(19) United States
(12) Patent Application Publication
(10) Pub. No.: US 2015/0120276 A1
(43) Pub. Date: Apr. 30, 2015

(54) INTELLIGENT GLASSES

(71) Applicants: Fu Tai Hua Industry (Shenzhen) Co., Ltd., Shenzhen (CN); HON HAI PRECISION INDUSTRY CO., LTD., New Taipei (TW)

(72) Inventor: JIAN-GUO WU, Shenzhen (CN)

(21) Appl. No.: 14/519,382

(22) Filed: Oct. 21, 2014

(30) Foreign Application Priority Data
Oct. 30, 2013 (CN) 201310521038.9

(51) Int. Cl. G06F 17/28; G02B 27/01

(52) U.S. Cl. CPC G06F 17/28; G02B 27/017; G02B 2027/0178
USPC 704/2

(57) ABSTRACT

An intelligent pair of glasses includes a frame, a pair of glasses held by the frame, an input unit, a camera unit, a projection device rotatably coupled to the frame, and a processor. The input unit generates a control signal for taking photos in response to user inputs. The processor includes a camera control module, a word identification module, a translation module, and a display control unit. The camera control module activates the camera unit and controls the camera unit to capture images according to the control signal to capture an image showing words in an initial language. The word identification module identifies the words shown in the in the image. The translation module translates the words identified in the initial language into words in a target language. The display control unit controls the projection device to project the translated words in the target language onto a surface.

### CROSS-REFERENCE TO RELATED APPLICATIONS

This application claims priority to Chinese Patent Application No. 201310521038.9 filed on Oct. 30, 2013, the contents of which are incorporated by reference herein.

### FIELD

The present disclosure relates to intelligent glasses, and particularly to a pair of intelligent glasses having a translation function.

### BACKGROUND

There are various types of glasses for eyewear, such as glasses for users who are myopia, hyperopia glasses, and sunglasses etc. Glasses have become important tools for users, and are worn by many users. However, wearing a conventional pair of glasses does help a user read words of a foreign language.

### BRIEF DESCRIPTION OF THE DRAWINGS

Implementations of the present technology will now be described, by way of example only, with reference to the attached figures.

FIG. 1 is a block diagram of a pair of glasses in accordance with an exemplary embodiment.

FIG. 2 is a schematic diagram of the pair of glasses of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The word “module,” and “unit” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device. The term “comprising,” when utilized, means “including, but not necessarily limited to”; it specifically indicates open-ended inclusion or membership in the so-described combination, group, series and the like.

The present disclosure is described in relation to an intelligent pair of glasses. The intelligent pair of glasses includes a frame, a pair of glasses held by the frame, an input unit, a camera unit, a projection device and a processor. The input unit generates a control signal for controlling taking photos in response to user inputs. The camera unit is arranged at a front portion of the frame. The projection device is rotatably coupled to the frame. The processor includes a camera control module, a word identification module, a translation module, and a display control unit. The camera control module activates the camera unit and controls the camera unit to capture images according to the generated control signal for controlling taking photos, thus to capture an image showing words in an initial language. The word identification module identified the words shown in the captured image. The translation module translates the identified words in the initial language into words in a target language. The display control unit controls the projection device to project the translated words in the target language onto a surface.

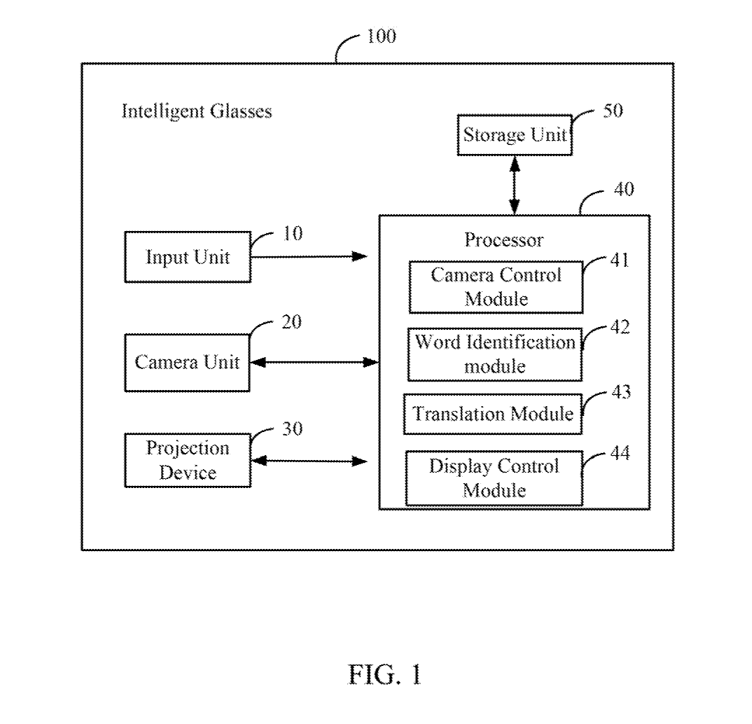

FIG. 1 illustrates a block diagram of an example intelligent pair of glasses 100 of the present disclosure. The pair of glasses 100 can include an input unit 10, a camera unit 20, a projection device 30, a processor 40, and a storage unit 50. In at least one embodiment, the input unit 10, the camera unit 20, the projection device 30 and the storage unit 50 are coupled to the processor 40 respectively. If a user takes a photo of a text with words need to be translated by using the camera unit 20, the pair of glasses 100 can automatically translate the text into a target text in a language predefined by the user. The pair of glasses 100 also can project the translated text on the lenses of the pair of glasses 100.

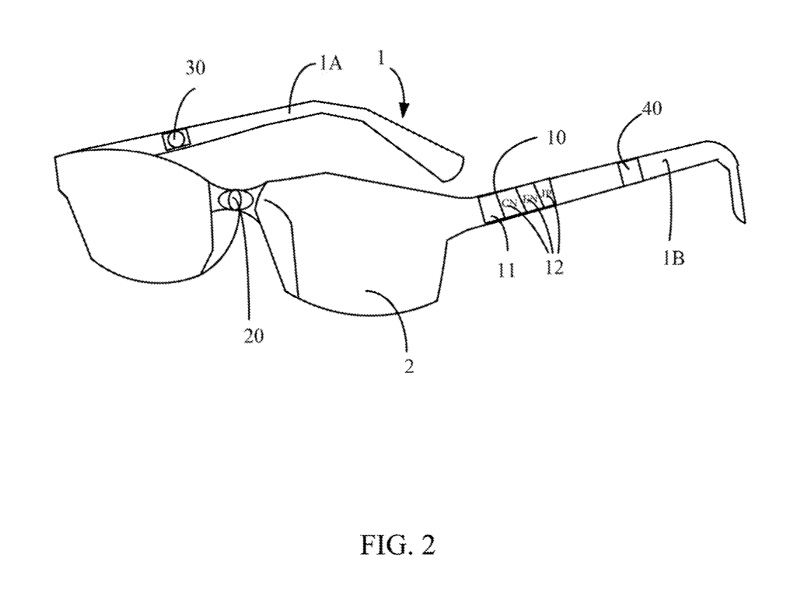

FIG. 2 illustrates an example schematic diagram of the pair of glasses 100 of FIG. 1. The pair of glasses 100 also can include a frame 1 and a pair of lenses 2 hold by the frame 1. In at least one embodiment, the pair of lenses 2 is translucent lenses, such as sunglasses, or other glasses having colors, etc. The input unit 10, the camera unit 20, the projection device 30, the processor 40 and the storage unit 50 are set on the frame 1.

The input unit 10 is arranged on a location of the frame 1 which can be conveniently operated such as depressed by the user, for example, a leg 1B of the frame 1, as shown in FIG. 2. The input unit 10 can be configured for generating input signals in response to the user's operation applied thereon. In at least one embodiment, the input unit 10 can include a number of buttons, such as photo button 11, language buttons 12, take for example. The input unit 10 generates a control signal for controlling taking photos in response to the photo button 11 being depressed by a user. The input unit 10 generates a control signal for determining a target language in response to the one of the language buttons 12 being operated by a user. In at least one embodiment, the language buttons 12 can include buttons associated with Chinese, English, and Japanese respectively.

The camera unit 20 can be a micro camera and is arranged at the front of the frame 1. The camera unit 20 is configured for capturing the image of the text that the user wants to be translated, and transmits the captured image to the processor 40. The user can adjust the pair of the glasses 100 to make the camera unit 20 facing the words in an initial language to be translated. The words in the initial language to be translated can be words on an advertising board, a signpost, a page of a book, a display screen etc.

The projection device 30 is rotatably coupled to a portion of the leg 1A of the frame 1 located close to the lens 2. When needed, the projection device 30 can be rotated for ensuring the projection plane of the projection device 30 facing one of the two lenses 2. Otherwise, the projection device 30 is rotated for ensuring the projection plane of the projection device 30 facing the leg 1A. In at least one embodiment, the projection device 30 can include a conventional telescopic and rotatable structure. The camera unit 30 can be a micro projector.

The storage unit 50 can store a number of words, phrases, and sentences in at least two languages, and a translation software. The at least two target languages are predefined by the user. In at least one embodiment, the storage unit 50 can store English, Chinese, and/or Japanese words, phrases, and sentences. The user can select a target language by operating one of the language buttons 12.

The processor 40 can include a camera control module 41, a word identification module 42, a translation module 43, and a display control module 44.

The camera control module 41 can be configured for activating the camera unit 20 and controlling the camera unit 20 to capture images according to the control signal for controlling taking photos generated by the input unit 10, thus to capture an image showing words in an initial language. In at least one embodiment, the initial language is a foreign language to the user of the pair of intelligent glasses 100. The user wants to translate the word in the initial language shown in captured image into words in a target language by the pair of glasses 100.

The word identification module 42 can be configured for identifying the words shown in the in the captured image captured by the camera unit 20.

The translation module 43 can be configured for translating the identified words in the initial language into words in the target language selected/predefined by the user.

The display control module 44 can be configured for controlling the projection device 30 to project the translated words in the target language onto a surface. In at least one embodiment, the projection device 30 projects the translated words in the target language onto the lens 2 facing the projection device 30. In an alternative embodiment, the projection device 30 can be rotated to face a projection screen or a wall for projection the translated words in the target language onto the projection screen or the wall.

The embodiments shown and described above are only examples. Many details are often found in the art such as the other features of a pair of glasses. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including, the full extent established by the broad general meaning of the terms used in the claims. It will therefore be appreciated that the embodiments described above may be modified within the scope of the claims.

What is claimed is:

1. An intelligent pair of glasses comprising:
a frame;
a pair of glasses held by the frame;
an input unit, configured for generating a control signal for taking photos in response to user inputs;
a camera unit, arranged at a front of the frame;
a projection device, rotatably coupled to the frame; and
a processor comprising:
a camera control module, configured for activating the camera unit and controlling the camera unit to capture images according to the control signal to capture an image showing words in an initial language;
a word identification module, configured for identifying the words shown in the in the image;
a translation module, configured for translating the words identified in the initial language into words in a target language; and
a display control unit, configured for controlling the projection device to project the translated words in the target language onto a surface.

2. The intelligent pair of glasses as claimed in claim 1, wherein the pair of lenses is translucent, and the display control module controls the projection device to project the translated words in the target language onto the pair of lenses.

3. The intelligent pair of glasses as claimed in claim 1, wherein the input unit comprises a plurality of buttons, the plurality of buttons comprises a photo button, and wherein the control signal is generated in response to the photo button being operated.

4. The intelligent pair of glasses as claimed in claim 3, wherein the plurality of buttons further comprises a plurality of language buttons, and the input unit generates a control signal for determining a target language in response to the one of the plurality of language buttons being operated.

5. The intelligent pair of glasses as claimed in claim 1, wherein the camera unit is a micro camera.

6. The intelligent pair of glasses as claimed in claim 1, wherein the projection device is a micro projector.

7. The intelligent pair of glasses as claimed in claim 1, wherein the pair of lens is selected form the group consisting of sunglasses and glasses having colors.
